(19) United States
(12) Patent Application Publication
(10) Pub. No.: US 2013/0328621 A1
(43) Pub. Date: Dec. 12, 2013

(54) SEMICONDUCTOR INTEGRATED CIRCUIT

(71) Applicant: Dong-Kyun KIM, Gyeonggi-do (KR)

(72) Inventor: Dong-Kyun KIM, Gyeonggi-do (KR)

(21) Appl. No.: 13/492,127

(22) Filed: Jun. 8, 2012

(51) Int. Cl. G05F 3/02

(52) U.S. Cl. 327/543; 327/538

(57) ABSTRACT

A semiconductor integrated circuit is provided. First and second voltage generation units generate a first voltage and a second voltage with respect to a temperature rise, respectively. First and second current generation units generate a first current and a second current having a negative characteristic with respect to a temperature rise in response to a voltage comparison signal, respectively. A voltage comparison unit compares a voltage level of a first current transfer node with a voltage level of a second current transfer node and generates the voltage comparison signal according to the comparison result. A reference voltage output unit is connected in series to the second voltage generation unit and outputs a reference voltage maintaining a set level, without regard to a temperature variation, in proportion to a third current generated in response to the voltage comparison signal.

### BACKGROUND

1. Field

Exemplary embodiments of the present invention relate to semiconductor design technology, and more particularly, to a circuit for generating a reference voltage having a stable level, without regard to process, voltage and temperature variations in a semiconductor integrated circuit.

2. Description of the Related Art

Most semiconductor integrated circuits, including DRAM, use external power supply voltages (e.g., VDD, VSS, etc.) and internal voltages having different levels from the external power supply voltages. In general, internal voltages are generated by a charge pumping method or a voltage down converting method using a reference voltage (VREF) corresponding to target levels thereof, an external power supply voltage (VDD), and an external ground voltage (VSS).

At this time, the most ideal is that the reference voltage (VREF) always has a constant voltage level without regard to PVT variations. That is, since voltage levels of internal voltages used in a semiconductor integrated circuit are determined corresponding to the level of the reference voltage VREF, it is a very important issue that the level of the reference voltage (VREF) maintains a stable state without regard to PVT variations of a semiconductor integrated circuit.

FIGS. 1 and 2 are circuit diagrams illustrating a widlar type reference voltage generation circuit applied to a conventional semiconductor integrated circuit.

Referring to FIG. 1, a widlar type reference voltage generation circuit applied to a conventional semiconductor integrated circuit includes a voltage generation unit 110, a first current generation unit 100, a second current generation unit 120, and a reference voltage output unit 140. The voltage generation unit 110 is configured to generate a voltage VGS2 having a negative characteristic with respect to a temperature rise. The first current generation unit 100 is configured to generate a first current I1 having a negative characteristic with respect to a temperature rise. The second current generation circuit 120 is connected to the first current generation unit 100 in a current mirror type, is connected in series to the voltage generation unit 110, and is configured to generate a second current I2 having a positive characteristic with respect to a temperature rise. The reference voltage output unit 140 is configured to output a reference voltage VREF maintaining a set level, without regard to a temperature variation, in proportion to a third current I3 generated by combining the first current I1 and the second current I2 at a set ratio.

In the conventional widlar type reference voltage generation circuit described above, the generation of the second current I2 having the positive characteristic with respect to the temperature rise can be explained using Equation 1 below.

$${I}_{D} = β {V}_{T}^{2} exp ( \frac{{V}_{GS} - {V}_{TH}}{{nV}_{T}} ) [ 1 - exp ( \frac{- {V}_{DS}}{{V}_{T}} ) ] \\ {I}_{1} = {β}_{1} {V}_{T}^{2} exp ( \frac{{V}_{GS} - {V}_{TH}}{{nV}_{T}} ) [ 1 - exp ( \frac{- {V}_{DS}}{{V}_{T}} ) ] \\ {I}_{2} = {β}_{2} {V}_{T}^{2} exp ( \frac{{V}_{GS 1} - {I}_{2} {R}_{1} - {V}_{TH}}{{nV}_{T}} ) [ 1 - exp ( \frac{- {V}_{DS 1}}{{V}_{T}} ) ] \\ ∵ {V}_{GS 1} - {I}_{2} {R}_{1} = {V}_{GS 2} , I 1 = I 2 \\ ∴ exp ( \frac{{I}_{2} {R}_{1}}{{nV}_{T}} ) = \frac{{β}_{2}}{{β}_{1}} \\ ∴ {I}_{2} = \frac{{nV}_{T}}{{R}_{1}} \cdot ln ( \frac{{β}_{2}}{{β}_{1}} ) \qquad Eq . 1$$

In Equation 1 above, ‘Vt’ is a thermal voltage, and ‘n’ is a value (1+C_depletion/C_ox) converging to 1. In addition, ‘Id’ is a weak inversion current of a second NMOS transistor MN2.

That is, the magnitude of ‘VGS1’ becomes equal to ‘VGS2+I2*R1’ due to the use of a first resistor R1, and the first current I1 and the second 12 which operate the second NMOS transistor MN2 in a weak inversion state and whose magnitude should be equal to each other by the current mirror type connection. Therefore, the magnitude of the second current I2 may have a positive characteristic with respect to a temperature variation.

However, the widlar type reference voltage generation circuit applied to the conventional semiconductor integrated circuit, illustrated in FIG. 1, has a limitation that the first resistor R1 should have a resistance larger than at least 40 kΩ in order that the second NMOS transistor MN2 operates at below a Zero Temperature Coefficient (ZTC).

In addition, the first resistor R1 should have a resistance larger than at least 45 kΩ in order that the second current I2 has a positive characteristic with respect to a temperature rise.

Moreover, the first resistor R1 should have a resistance larger than at least 70 kΩ in order that the variation in the level of the reference voltage VREF according to the variation in the level of the external power supply voltage VDD is controlled below 10 mV.

As such, in order to reduce the level variation dependency of the reference voltage VREF according to the variation in the level of the external power supply VDD, the first resistor R1 should have a resistance larger than 70 kΩ. As the resistance of the resistor R1 increases, the positive characteristic of the second current I2 with respect to the temperature rise is reduced. Therefore, it is not easy to control the temperature coefficient of the reference voltage VREF.

The circuit size of the conventional widlar type reference voltage generation circuit illustrated in FIG. 1 may be controlled through the layout symmetry as illustrated in FIG. 2, so that it operates when the resistance of the first resistor R1 is about 55 kΩ, ‘VGS2’ maintains a magnitude of 280 mV, the second current I2 maintains a magnitude of 115 nA, the variation range of the reference voltage VREF according to the variation in the level of the external power supply voltage VDD is below 10 mV, and the magnitude of a current sinking through an external ground voltage (VSS) terminal is below 10 uA. However, this slightly reduces the resistance of the first resistor R1, and it is still difficult to control the temperature coefficient of the reference voltage VREF.

### SUMMARY

An embodiment of the present invention is directed to a semiconductor integrated circuit including a widlar type reference voltage generation circuit which can easily control a temperature coefficient of a reference voltage.

In accordance with an embodiment of the present invention, a semiconductor integrated circuit includes: a first voltage generation unit configured to generate a first voltage having a negative characteristic with respect to a temperature rise; a second voltage generation unit configured to generate a second voltage having a negative characteristic with respect to a temperature rise; a first current generation unit configured to generate a first current having a negative characteristic with respect to a temperature rise in response to a voltage comparison signal; a second current generation unit connected in series to the first voltage generation unit and configured to generate a second current having a positive characteristic with respect to a temperature rise in response to the voltage comparison signal; a voltage comparison unit configured to compare a voltage level of a first current transfer node, at which the first current is sourced, with a voltage level of a second current transfer node, at which the second current is sourced, and generate the voltage comparison signal according to the comparison result; and a reference voltage output unit connected in series to the second voltage generation unit and configured to output a reference voltage maintaining a set level, without regard to a temperature variation, in proportion to a third current generated in response to the voltage comparison signal.

### BRIEF DESCRIPTION OF THE DRAWINGS

FIGS. 1 and 2 are circuit diagrams illustrating a widlar type reference voltage generation circuit applied to a conventional semiconductor integrated circuit.

FIG. 3 is a circuit diagram illustrating a widlar type reference voltage generation circuit applied to a semiconductor integrated circuit in accordance with an embodiment of the present invention.

FIGS. 4A to 4C are graphs for comparing the operation of the widlar type reference voltage generation circuit in accordance with the embodiment of the present invention with the operation of the conventional widlar type reference voltage generation circuit.

FIGS. 5A and 5B are graphs for comparing the variation in the level of a reference voltage generated by the widlar type reference voltage generation circuit in accordance with the embodiment of the present invention with the variation in the level of a reference voltage generated by the conventional widlar type reference voltage generation circuit.

FIGS. 6A to 6C are graphs for explaining a difference between the widlar type reference voltage generation circuit in accordance with the embodiment of the present invention and the conventional widlar type reference voltage generation circuit in a mismatch simulation state.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

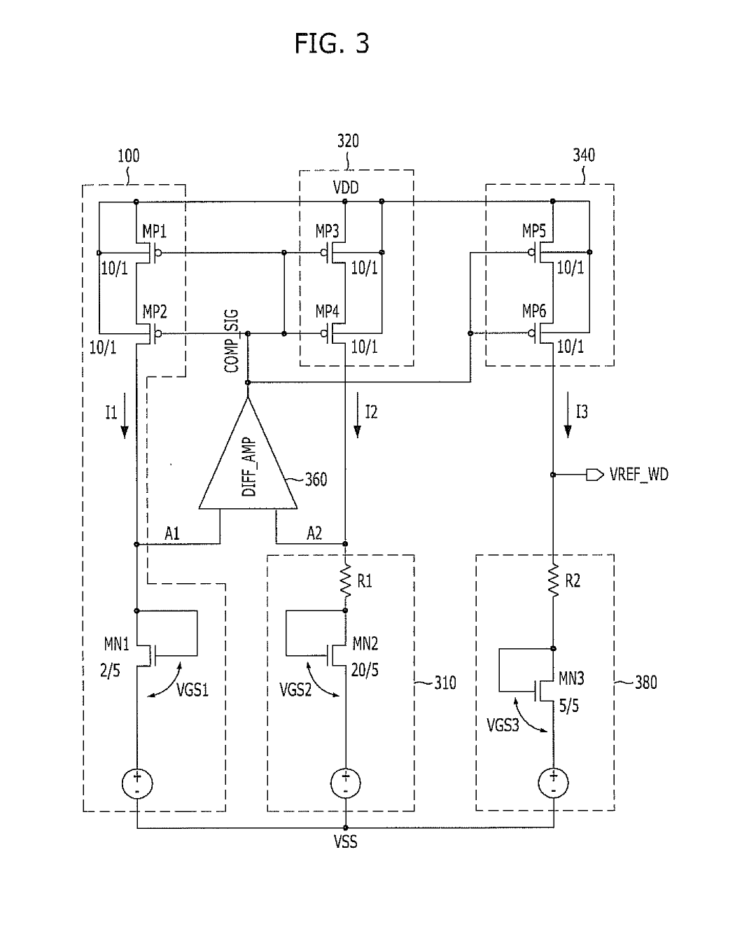

FIG. 3 is a circuit diagram illustrating a widlar type reference voltage generation circuit applied to a semiconductor integrated circuit in accordance with an embodiment of the present invention.

Referring to FIG. 3, the widlar type reference voltage generation circuit applied to the semiconductor integrated circuit in accordance with an embodiment of the present invention includes a first voltage generation unit 310, a second voltage generation unit 380, a first current generation unit 300, a second current generation unit 320, a voltage comparison unit 360, and a reference voltage output unit 340. The first voltage generation unit 310 is configured to generate a first voltage VGS2 having a negative characteristic with respect to a temperature rise. The second voltage generation unit 380 is configured to generate a second voltage VGS3 having a negative characteristic with respect to a temperature rise. The first current generation unit 300 is configured to generate a first current I1 having a negative characteristic with respect to a temperature rise in response to a voltage comparison signal COMP_SIG. The second current generation unit 320 is connected in series to the first voltage generation unit 310 and is configured to generate a second current I2 having a positive characteristic with respect to a temperature rise in response to the voltage comparison signal COMP_SIG. The voltage comparison unit 360 is configured to compare a voltage of a first current transfer node I1_NODE and a second current transfer node I2_NODE and generate the voltage comparison signal COMP_SIG according to the comparison result. The reference voltage output unit 340 is connected in series to the second voltage generation unit 380 and is configured to output a reference voltage VREF maintaining a set level, without regard to a temperature variation, in proportion to a third current I3 generated in response to the voltage comparison signal COMP_SIG.

Specifically, the first current generation unit 300 includes first and second PMOS transistors MP1 and MP2 and a first NMOS transistor MN1. The first and second PMOS transistors MP1 and MP2 are connected in series between an external power supply voltage (VDD) terminal and the first current transfer node I1_NODE and controls the magnitude of the first current I1 in response to the voltage comparison signal COMP_SIG applied to gates thereof. The first NMOS transistor MN1 is a diode-connected transistor that is connected between the first current transfer node I1_NODE and the external ground voltage (VSS) terminal and is configured to generate a third voltage VGS1 having a negative characteristic with respect to a temperature rise between a gate and a source.

The first voltage generation unit 310 includes a first resistor R1 and a second NMOS transistor MN2 connected in series between the second current transfer node I2_NODE and the external ground voltage (VSS) terminal. At this time, the second NMOS transistor MN2 has a drain and a source connected together and thus operates as a diode. Also, the second NMOS transistor MN2 generates the first voltage VGS2 between the gate and the source thereof.

The second current generation unit 320 includes third and fourth PMOS transistors MP3 and MP4 connected in series between the external power supply voltage (VDD) terminal and the second current transfer node I2_NODE and configured to control the magnitude of the second current I2 in response to the voltage comparison signal COMP_SIG applied to gates thereof.

The voltage comparison unit 360 includes a differential amplifier DIFF_AMP configured to compare voltage levels of the first current transfer node I1_NODE and the second current transfer node I2_NODE and control the voltage level of the voltage comparison signal COMP_SIG in order to make the two nodes virtually shorted.

The second voltage generation unit 380 includes a second resistor R2 and a third NMOS transistor MN3 connected in series between a reference voltage output node VREF_OUTND and the external ground voltage (VSS) terminal. At this time, the third NMOS transistor MN3 has a drain and a source connected together and thus operates as a diode. Also, the third NMOS transistor MN3 generates the second voltage VGS3 between the gate and the source thereof.

The reference voltage output unit 340 includes third and fourth PMOS transistors MP3 and MP4 connected in series between the external power supply voltage (VDD) terminal and the reference voltage output node VREF_OUTND and configured to control the magnitude of the third current I3 in response to the voltage comparison signal COMP_SIG applied to gates thereof.

The generation of the second current I2 having the positive characteristic with respect to the temperature rise in the above-mentioned widlar type reference voltage generation circuit in accordance with the embodiment of the present invention can be explained using Equation 2 below.

$${I}_{D} = β {V}_{T}^{2} exp ( \frac{{V}_{GS} - {V}_{TH}}{{nV}_{T}} ) [ 1 - exp ( \frac{- {V}_{DS}}{{V}_{T}} ) ] \\ {I}_{1} = {β}_{1} {V}_{T}^{2} exp ( \frac{{V}_{GS 1} - {V}_{TH}}{{nV}_{T}} ) [ 1 - exp ( \frac{- {V}_{DS 1}}{{V}_{T}} ) ] \\ {I}_{2} = {β}_{2} {V}_{T}^{2} exp ( \frac{{V}_{GS 1} - {I}_{2} {R}_{1} - {V}_{TH}}{{nV}_{T}} ) [ 1 - exp ( \frac{- {V}_{DS 1}}{{V}_{T}} ) ] \\ ∵ {V}_{GS 1} - {I}_{2} {R}_{1} = {V}_{GS 2} , I 1 = I 2 \\ ∴ exp ( \frac{{I}_{2} {R}_{1}}{{nV}_{T}} ) = \frac{{β}_{2}}{{β}_{1}} \\ ∴ {I}_{2} = \frac{{nV}_{T}}{{R}_{1}} \cdot ln ( \frac{{β}_{2}}{{β}_{1}} ) \\ {I}_{2} = {I}_{3} \\ ∴ VREF\_WD = \frac{{R}_{2} {V}_{T}}{{R}_{1}} \cdot ln ( \frac{{β}_{2}}{{β}_{1}} ) + {V}_{THN 3} \qquad Eq . 2$$

In Equation 2, ‘Vt’ is a thermal voltage, and ‘n’ is a value (1+C_depletion/C_ox) converging to 1. In addition, ‘Id’ is a weak inversion current of the second NMOS transistor MN2.

Due to the operation of the voltage comparison unit 360 in the virtual short state, the voltage levels of the first current transfer node I1_NODE and the second current transfer node I2_NODE can be considered to be equal to each other. In addition, since the level of the first current transfer node I1_NODE and the level of the third voltage VGS1 are equal to each other, the levels of the second current transfer node I2_NODE and the third voltage VGS1 can be considered to be equal to each other. Therefore, the level of the voltage VR1 applied across the first resistor is equal to a value obtained by subtracting the level of the first voltage VGS2 from the level of the third voltage VGS1.

In summary, the level of the third voltage VGS1 is equal to the sum of the first voltage VGS2 and the voltage VR1 applied across the first resistor R1 by the second current I2. That is, as proved by Equation 1 above, the equation of the conventional reference voltage generation circuit, that is, VGS1=VGS2+I2*R1, is equally applied.

In addition, since the second NMOS transistor MN2 in the reference voltage generation circuit in accordance with the embodiment of the present invention also operates in a weak inversion state, the magnitude of the second current I2 may have a positive characteristic with respect to a temperature variation.

Since the second current I2 and the third current I3 are generated in response to the voltage comparison signal COMP_SIG, their magnitudes may be considered to be equal to each other. Therefore, the equation corresponding to Equation 2 can be valid. The reference voltage VREF can control the temperature coefficient by appropriately controlling the magnitudes of the first resistor R1 and the second resistor R2.

Since the conventional reference voltage generation circuit controls the temperature coefficient of the reference voltage VREF by adjusting the magnitude of the single resistor R1, it is not easy to control the temperature coefficient of the reference voltage VREF. In contrast, since the reference voltage generation circuit in accordance with the embodiment of the present invention controls the temperature coefficient of the reference voltage VREF by appropriately adjusting the magnitude ratio of the first resistor R1 and the second resistor R2, it is easy to control the temperature coefficient of the reference voltage VREF.

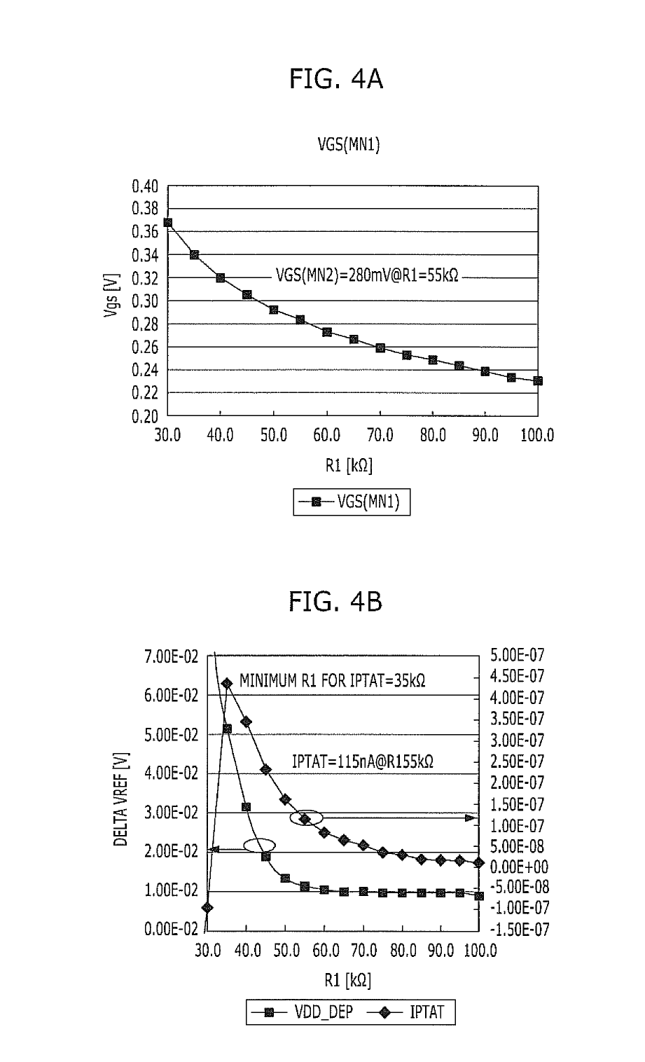

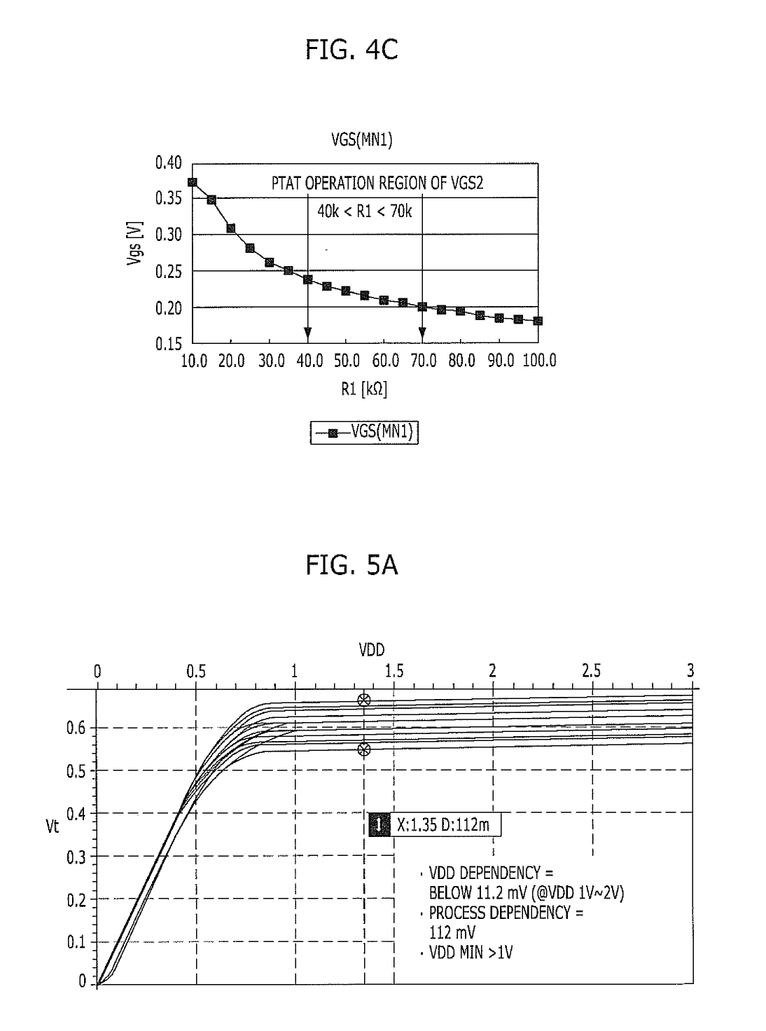

FIG. 4A to 4C are graphs for comparing the operation of the widlar type reference voltage generation circuit in accordance with the embodiment of the present invention with the operation of the conventional widlar type reference voltage generation circuit.

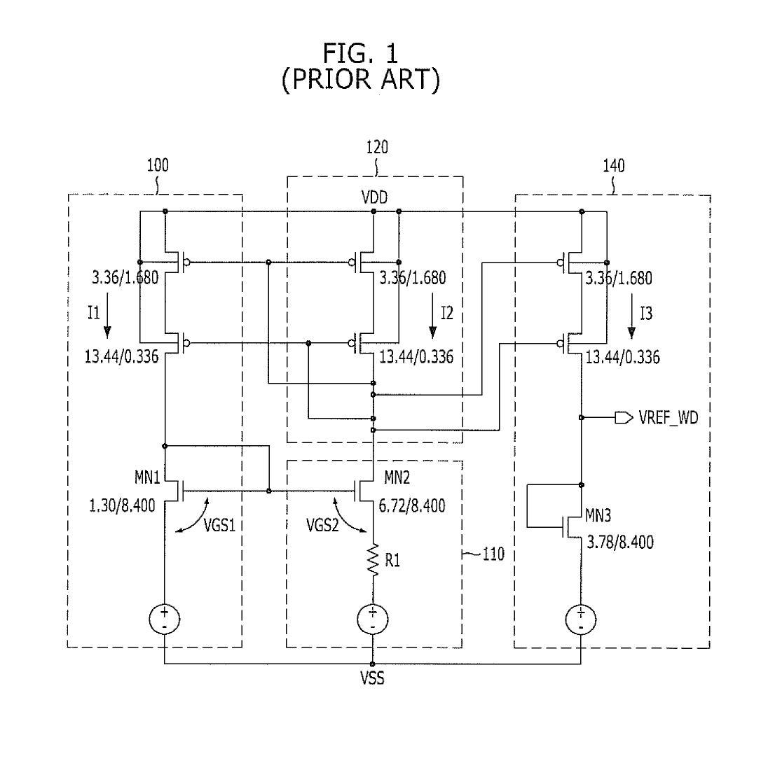

FIG. 4A is a graph for the conventional widlar type reference voltage generation circuit illustrated in FIG. 1. It can be seen from FIG. 4A that the variation in the level of the first voltage VGS2 is very rapid as the resistance of the first resistor R1 is varied, and the first resistor R1 should have a resistance larger than at least 40 kΩ in order that the second NMOS transistor MN2 operates at below a ZTC.

In addition, it can be seen that the first resistor R1 is required to have a resistance of at least 45 kΩ in order that the second current I2 maintains the positive characteristic according to the temperature rise.

Furthermore, the first resistor R1 should have a resistance larger than at least 70 kΩ in order that the level of the reference voltage VREF according to the variation in the level of the external power supply voltage VDD is controlled below ‘10 mV’.

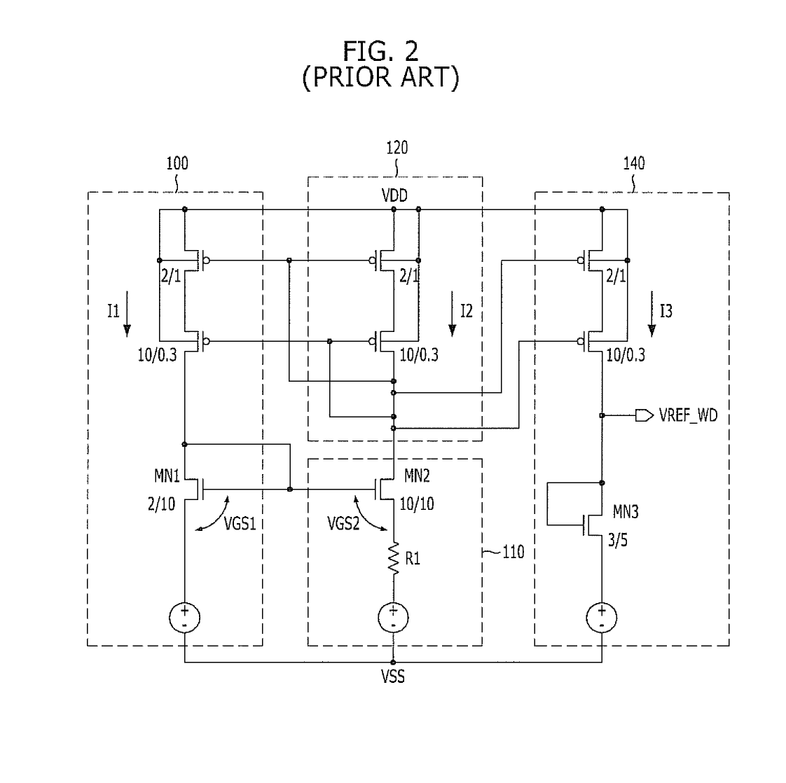

FIG. 4B is a graph for the conventional widlar type reference voltage generation circuit illustrated in FIG. 2. Although less than the graph of FIG. 4A, the variation in the level of the first voltage VGS2 is very rapid as the resistance of the first resistor R1 is varied, and the first resistor R1 should maintain a resistance of 55 kΩ in order that the first voltage VGS2 has a resistance of 280 mV.

In addition, it can be seen that the first resistor R1 is required to have a resistance of at least 35 kΩ in order that the second current I2 maintains the positive characteristic according to the temperature rise.

Furthermore, the first resistor R1 should have a resistance larger than at least 70 kΩ in order that the level of the reference voltage VREF according to the variation in the level of the external power supply voltage VDD is controlled below ‘10 mV’. When the first resistor R1 maintains a resistance of 55 kΩ, the second current I2 is 115 nA.

FIG. 4C is a graph for the widlar type reference voltage generation circuit of FIG. 3 in according to the embodiment of the present invention. As the magnitude of the first resistor R1 is varied, the variation in the level of the first voltage VGS2 is reduced. Therefore, the first resistor R1 may have a resistance of 40 kΩ to 70 kΩ in order that the second current I2 has 250 mV to 200 mV which is an operating range of the first voltage VGS2 at which the second current I2 has the positive characteristic according to the temperature rise.

In addition, it can be seen that the first resistor R1 is required to have a resistance of at least 20 kΩ in order that the second current I2 maintains the positive characteristic according to the temperature rise.

In addition, the first resistor R1 has only to be larger than at least 40 kΩ in order that the variation in the voltage of the reference voltage VREF according to the variation in the level of the external power supply voltage VDD is controlled below 10 mV. Also, the second current I2 is as much as 150 nA when the first resistor R1 maintains 40 kΩ.

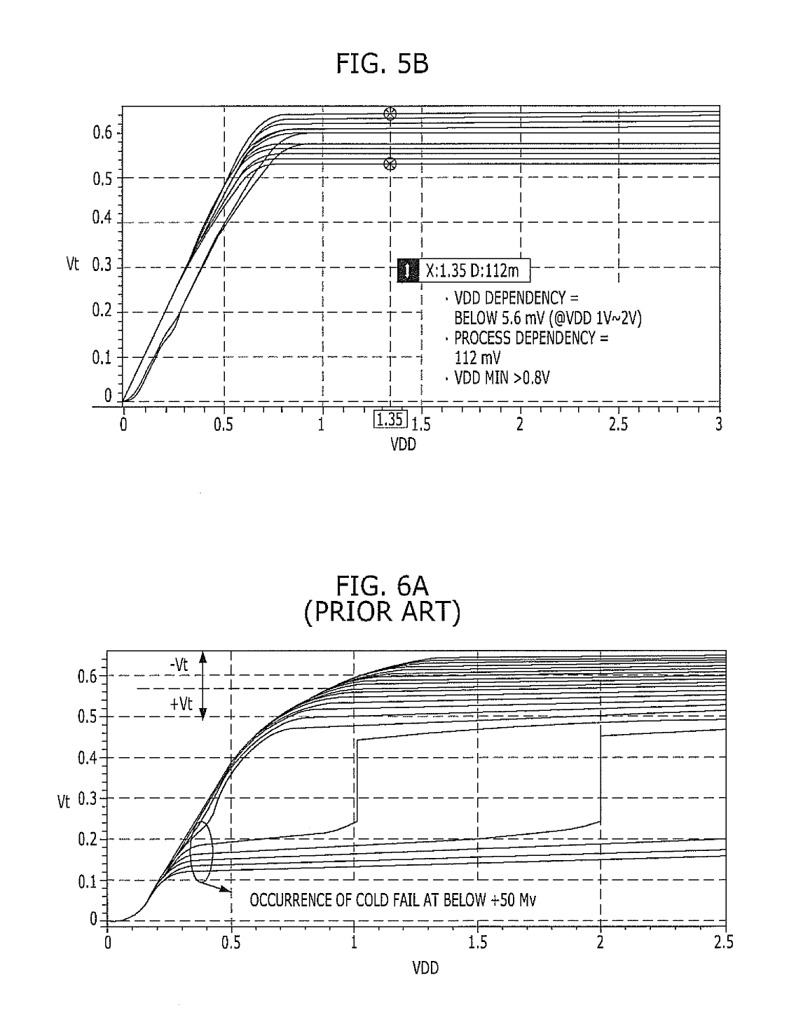

FIGS. 5A and 5B are graphs for comparing the variation in the level of a reference voltage generated by the widlar type reference voltage generation circuit in accordance with the embodiment of the present invention with the variation in the level of a reference voltage generated by the conventional widlar type reference voltage generation circuit.

FIG. 5A is a graph showing the variation in the level of the reference voltage VREF generated by the conventional widlar type reference voltage generation circuit. The dependency on the external power supply voltage VDD is as much as 11.2 my, and the level of the external power supply voltage VDD, which should be minimally maintained, is 1 V.

FIG. 5B is a graph showing the variation in the level of the reference voltage VREF generated by the widlar type reference voltage generation circuit in accordance with the embodiment of the present invention. The dependency on the external power supply voltage VDD is as much as 5.6 mV, which is reduced by half compared to the conventional art. Also, the level of the external power supply voltage VDD, which should be minimally maintained, is merely 0.8 V. Therefore, the reference voltage generation circuit in accordance with the embodiment of the present invention is further suitable to a low-power semiconductor integrated circuit, as compared to the conventional art.

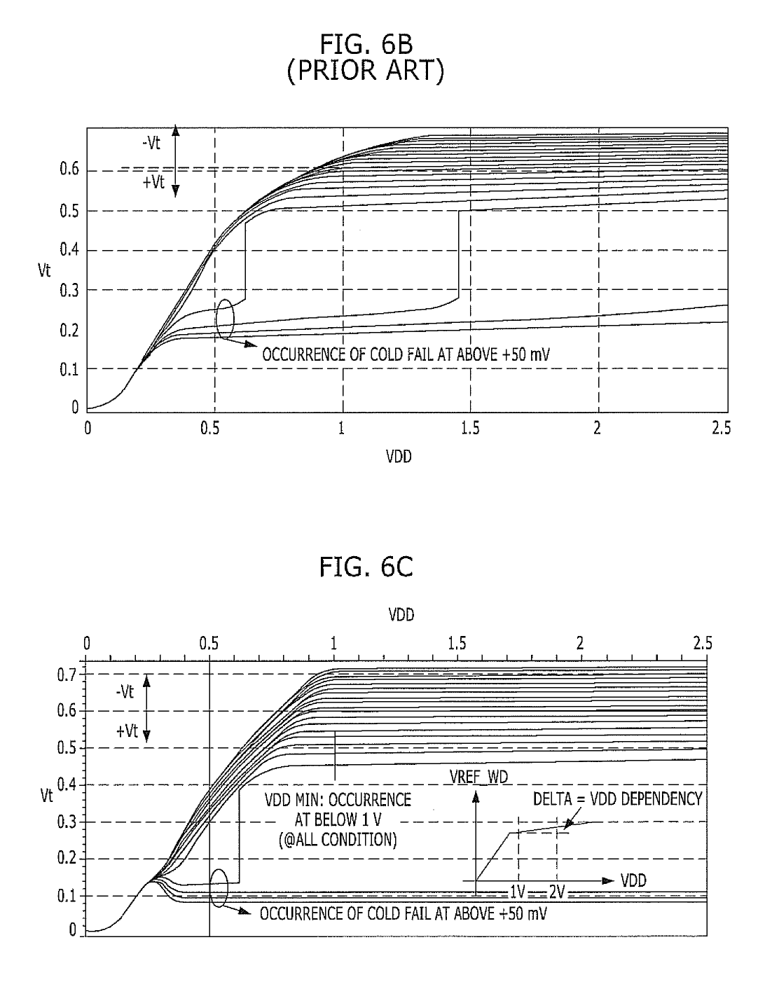

FIGS. 6A to 6C are graphs for explaining a difference between the widlar type reference voltage generation circuit in accordance with the embodiment of the present invention and the conventional widlar type reference voltage generation circuit in a mismatch simulation state.

The mismatch simulation for the reference voltage generation circuit is performed to appropriately adjust a value of ‘Vt’ corresponding to the thermal voltage and measure a relevant operation.

FIG. 6A is a graph for the conventional widlar type reference voltage generation circuit of FIG. 1. As can be seen from FIG. 6A, when the level of ‘Vt’ corresponding to the thermal voltage is higher than 50 mV, cold fail occurs and the reference voltage generation circuit has very poor characteristics.

FIG. 6B is a graph for the conventional widlar type reference voltage generation circuit of FIG. 2. As can be seen from FIG. 6B, when the level of ‘Vt’ corresponding to the thermal voltage is higher than 70 mV, cold fail occurs and the reference voltage generation circuit has very poor characteristics. However, the dependency on the external power supply voltage VDD is above 1.3 V.

FIG. 6C is a graph for the widlar type reference voltage generation circuit of FIG. 3. As can be seen from FIG. 6C, when the level of ‘Vt’ corresponding to the thermal voltage is higher than 70 mV, cold fail does not occur and the reference voltage generation circuit has very good characteristics. In addition, the dependency on the external power supply voltage VDD is below 1 V.

The operation of FIGS. 6A to 6C is summarized in Table 1 below. The widlar type reference voltage generation circuit in accordance with the embodiment of the present invention is excellent in all characteristics.

TABLE 1

| | Conventional | Normalized | Embodiment of |
|---|---|---|---|
| | Art | Conventional Art | Present Invention |
| Item | (FIG. 1) | (FIG. 2) | (FIG. 3) |
| Cold fail ΔVt | +50 mV≧ | +70 mV≧ | +70 mV≧ |
| VDD dependency | 15 mV | 17 mV | 5.23 mV |
| (on ΔVt ± 30 mV) | | | |

Accordingly, the widlar type reference voltage generation circuit in accordance with the embodiment of the present invention can easily adjust the temperature coefficient of the reference voltage VREF through the resistance ratio control (R2/R1) based on the circuit modification.

Therefore, the variation in the level of the reference voltage VREF according to the variation in the level of the external power supply voltage VDD can be significantly reduced as compared to the conventional art.

In addition, the operable minimum level of the external power supply voltage VDD can be significantly reduced as compared to the conventional art.

Moreover, the value of the thermal voltage (Vt) at which cold fail occurs can be significantly increased as compared to the conventional art.

While the present invention has been described with respect to the specific embodiments, it will be apparent to those skilled in the art that various changes and modifications may be made without departing from the spirit and scope of the invention as defined in the following claims.

For example, the positions and kinds of the logic gates and the transistors set forth above may be differently implemented according to the polarities of the input signals.

What is claimed is:

1. A semiconductor integrated circuit comprising:
a first voltage generation unit configured to generate a first voltage having a negative characteristic with respect to a temperature rise;
a second voltage generation unit configured to generate a second voltage having a negative characteristic with respect to a temperature rise;
a first current generation unit configured to generate a first current having a negative characteristic with respect to a temperature rise in response to a voltage comparison signal;
a second current generation unit connected in series to the first voltage generation unit and configured to generate a second current having a positive characteristic with respect to a temperature rise in response to the voltage comparison signal;
a voltage comparison unit configured to compare a voltage level of a first current transfer node, at which the first current is sourced, with a voltage level of a second current transfer node, at which the second current is sourced, and generate the voltage comparison signal according to the comparison result; and
a reference voltage output unit connected in series to the second voltage generation unit and configured to output a reference voltage maintaining a set level, without regard to a temperature variation, in proportion to a third current generated in response to the voltage comparison signal.

2. The semiconductor integrated circuit of claim 1, wherein the first current generation unit comprises:
first and second PMOS transistors connected in series between an external power supply voltage terminal and the first current transfer node and configured to adjust the magnitude of the first current in response to the voltage comparison signal applied to gates thereof; and
a first NMOS transistor connected between the first current transfer node and an external ground voltage terminal and configured to generate a third voltage having a negative characteristic with respect to a temperature rise, wherein the first NMOS transistor has a diode-connected configuration in which a drain and a source thereof are connected together.

3. The semiconductor integrated circuit of claim 2, wherein the first voltage generation unit comprises:
a first resistor and a second NMOS transistor connected in series between the second current transfer node and the external ground voltage terminal, the second NMOS transistor having a drain and a source connected together to thereby operate as a diode and generate the first voltage between a gate and the source thereof.

4. The semiconductor integrated circuit of claim 3, wherein the second current generation unit comprises:
third and fourth PMOS transistors connected in series between the external power supply voltage terminal and the second current transfer node and configured to adjust the magnitude of the second current in response to the voltage comparison signal applied to gates thereof.

5. The semiconductor integrated circuit of claim 4, wherein the voltage comparison unit comprises a differential amplifier configured to compare voltage levels of the first current transfer node and the second current transfer node and adjust the voltage level of the voltage comparison signal in order to make the first current transfer node and the second current transfer node virtually shorted.

6. The semiconductor integrated circuit of claim 5, wherein the second voltage generation unit comprises:
a second resistor and a third NMOS transistor connected in series between a reference voltage output node and the external ground voltage terminal the third NMOS transistor MN3 having a drain and a source connected together to thereby operates as a diode and generate the second voltage between a gate and the source thereof.

7. The semiconductor integrated circuit of claim 6, wherein the reference voltage output unit comprises:
third and fourth PMOS transistors connected in series the external power supply voltage terminal and the reference voltage output node and configured to adjust the magnitude of the third current in response to the voltage comparison signal applied to gates thereof
